(19) United States
(12) Patent Application Publication
(10) Pub. No.: US 2015/0321459 A1
(43) Pub. Date: Nov. 12, 2015

(54) DEVICE FOR THE HYDRODYNAMICALLY BONDING OF NONWOVEN, WOVEN OR KNITTED FABRICS

(71) Applicant: TRÜTZSCHLER GMBH & CO. KG, Mönchengladbach (DE)

(72) Inventor: JÜRGEN FRISCH, Erzhausen (DE)

(21) Appl. No.: 14/441,983

(22) PCT Filed: Jul. 20, 2013
(86) PCT No.: PCT/EP2013/002155

§ 371 Date: May 11, 2015

(30) Foreign Application Priority Data
Nov. 9, 2012 (DE) 10 2012 110 741.6

(51) Int. Cl. B32B 37/10; D04H 1/492; B32B 37/00

(52) U.S. Cl. CPC B32B 37/10; B32B 37/0046; D04H 1/492; B32B 2437/00

(57) ABSTRACT

The invention relates to a device for the hydrodynamic bonding of nonwovens, wovens or knitted fabrics comprising a suction pipe having a plurality of drilled holes, a structure drum set at a distance from the suction pipe, characterized by the distance between suction pipe and structure drum being set by spacer elements.

The invention relates to a device for the hydrodynamic bonding of nonwovens, wovens or knitted fabrics in which liquid, for example water, is sprayed from a plurality of nozzles onto the fabric to be bonded. The fabric to be bonded runs over a rotating drum that is permeable to liquids; the drum can also be subjected to suction in order to remove the water. The o drum normally comprises a massive cylindrical suction pipe with holes for ensuring a large water drainage flow. At a distance from the suction pipe, a structured drum is pulled over the said pipe, the fine perforations of the said drum can bond the fibers of the fabric to be processed but can also produce a surface structure in the form of a pattern.

The structure drum, together with the suction pipe, is always supplied as state-of-the-art technology and used as a replacement in the plant. The suction pipe and its components must always be replaced together with the structure drum, especially when the plant has to be converted to process a different fabric or has to produce a different fabric surface and the drum diameter has to be changed to achieve this. This means that the conversion is very time-consuming because of the installation time and very expensive for the customer as a new structure drum for the processing of new nonwovens has always had to be purchased together with a suction pipe and its components.

The purpose of this invention is to create a device for the hydrodynamic bonding of nonwovens, wovens and knitted fabrics that can be set up cost-effectively and can be replaced with little effort.

The invention solves this problem by the teaching according to claim 1; further advantageous design features of the invention are characterized by the sub-claims.

According to the technical teaching of claim 1, the device for the hydrodynamic bonding of nonwovens, wovens or knitted fabrics comprises the suction pipe with a plurality of holes, a structure drum arranged at a distance from the suction pipe whereby the distance between suction pipe and structure drum can be set using replaceable spacer elements.

It is then only necessary to replace the spacer elements if a new structure drum with a different outer diameter is to be used in the plant. With a new structure drum, the associated suction pipe does not have to be purchased—which is more profitable for the plant operator as fewer parts have to be acquired.

An advantageous embodiment of the invention is that the suction pipe possesses spacer elements that are attached to the suction pipe. The suction pipe can therefore remain in the plant and does not have to be replaced. The time to replace the structure drum can be reduced considerably, so increasing the plant availability.

A further improvement is achieved by fixing the spacer elements to the suction pipe by means of clamps. The clamps are attached to the suction pipe using fasteners which clamp the spacer elements firmly to the suction pipe. This therefore makes fitting and dismantling very simple and reliable.

As the spacer elements can be replaced/fixed on the suction pipe, the structure drum can be slid over the spacer elements from the operator end. The fitting and removal of the structure drum is done from one end, whereby the suction pipe remains fixed in the plant. The time required for changing the structure drum is therefore considerably reduced.

An advantageous embodiment is that the structure drum can be attached to the suction pipe in the region of the suction end by means of a replaceable adapter ring. This end face of the structure drum could naturally also be attached, diameter-independent, to the suction pipe; the adaptation of the adapter ring however increases the torque to be transferred and the torsional stiffness of the structure drum.

In a further improvement, an end face of the structure drum engages with a recess in the adapter ring and is fixed there by means of a tapered element and a clamping ring. This results in a reliable, clamped connection for the structure drum which can transfer high torques.

In a further advantageous embodiment, an end face of the structure drum at the operator end is attached to a centering device. The centering device can be so designed that it can be universally used for all outer diameters of structure drums. When replacing a structure drum, it is therefore only necessary to replace the spacer elements and, if necessary, the adapter ring with the clamping elements for the end face on the suction end.

It is therefore no longer necessary, each time the structure drum is replaced, to purchase and stock the matching suction pipe and its components. The removal of the complete suction pipe is also saved, so reducing the time needed and increasing the plant availability.

The invention is explained below in more detail using the schematic representation of a possible design as an example. It shows:

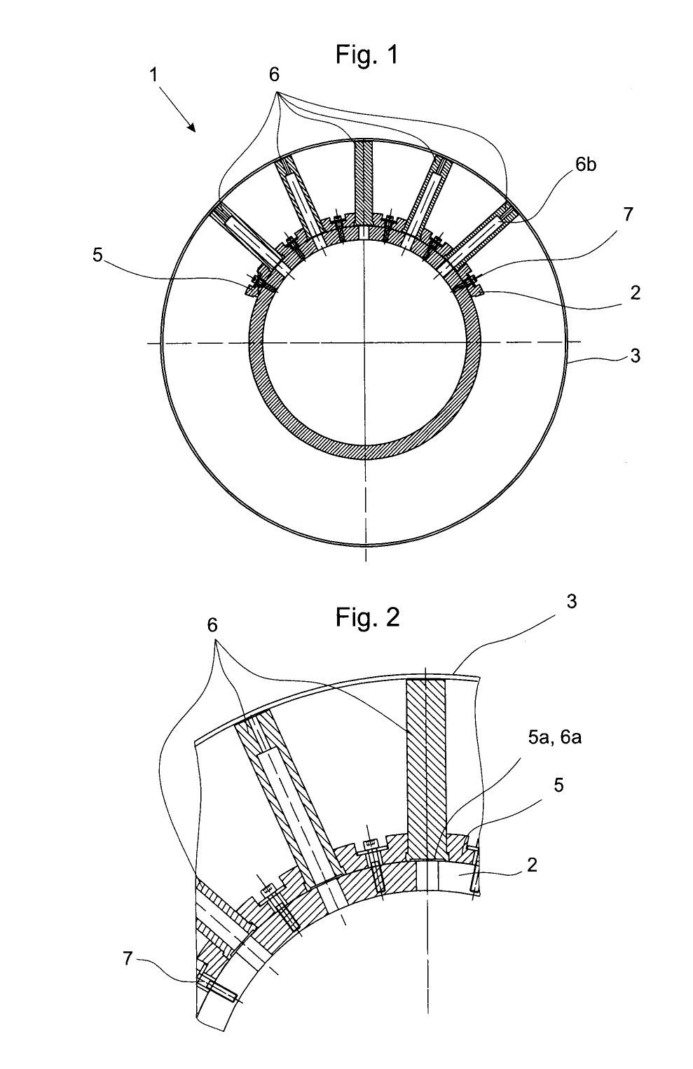

FIG. 1: The cross-section of a drum

FIG. 2: An enlarged, detailed cross-section of a drum

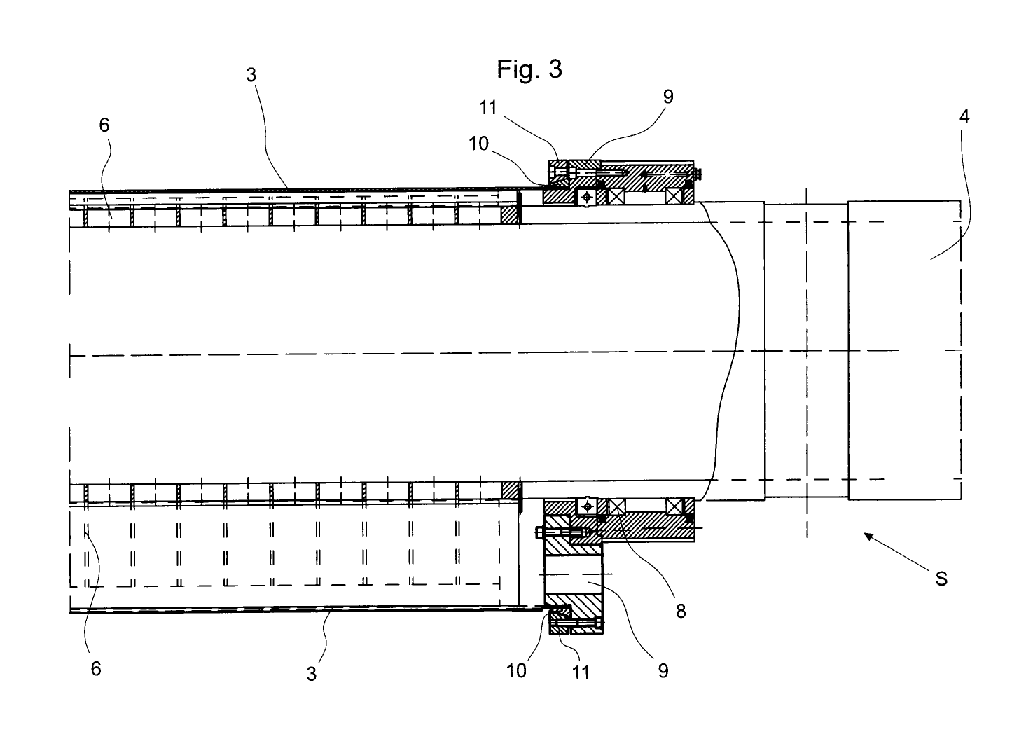

FIG. 3: A longitudinal cross-section of a drum in the region of an end face

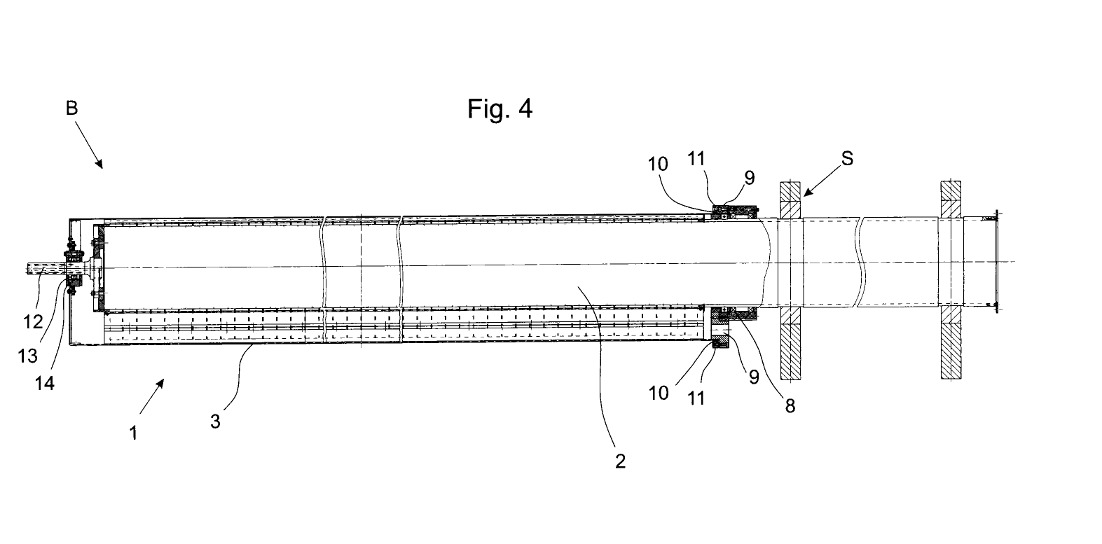

FIG. 4: A longitudinal cross-section of a drum

A drum 1 is shown in FIGS. 1 and 2 that essentially comprises a suction pipe 2 and a structure drum 3. The drum 1 is part of a process plant that is not shown here in which a web of nonwoven or knitted fibers is bonded by means of high-energy jets and, if necessary, given a pattern.

The suction pipe 2 on the other hand can be manufactured from a heavy cylinder and then fitted with a plurality of clamps 5 and spacer elements 6. The suction pipe 2 has a plurality of holes for draining off large quantities of liquid. The structure drum 3 can be formed from thin metal sheeting or woven fabric that has a plurality of holes and, if necessary, a structured surface. The clamps 5 are formed as long strips that extend along the longitudinal axis of the suction pipe 2. The clamps 5 also have recesses 5a that correspond to the feet 6a of the spacer elements 6. The clamps 5 are connected to the suction pipe 2 by the fasteners 7 and so hold the spacer elements 6 in place. The spacer elements 6 therefore stand perpendicular to the surface of the suction pipe 2. The structure drum 3 can now be slid over the spacer elements 6.

The suction end S of drum 1 is shown in FIG. 3. The suction pipe 2 has a bearing 8 at this end to which an adapter ring 9 is attached. The adapter ring 9 has a recess into which an openly formed end-face of the structure drum 3 can engage. The end face of the structure drum 3 is clamped to the adapter ring 9 via a tapered element 10 under an associated clamp ring 11. The upper part of FIG. 3 shows as an example a drum 1 with an outer diameter of approx. 500 mm; whereas in the lower region drum 1 has an outer diameter of approx. 800 mm. It can be seen in both designs that the spacer elements 6 as well as the fixing on the end face of the structure drum 3, i.e. adapter ring 9, taper 10 and clamp ring 11 have changed in diameter. The suction pipe 2 with the clamps 5 is identical.

At the operator end B of the drum 1 in FIG. 4, the suction pipe 2 is connected to a journal 12. On the journal 12 is in turn a bearing 13 with a centering device 14, the latter supporting and holding the said bearing of the second end face of the structure drum 3.

To avoid keeping a suction pipe 2 and associated components in stock for converting the plant to a different drum diameter, removal of the structure drum 3, changing the spacer elements 6 and fitting a modified structure drum 3 with a different outer diameter suffice. To do this, the structure drum 3 is detached from the clamp ring 11 with the taper 10 at the suction end S. At the operator end B, the structure drum 3 is freed from the centering device 14 and can therefore be slid over the spacer elements 6 of the suction pipe 2. The spacer elements 6 are then removed from the clamps 5. Because of a new outer diameter, the adapter ring 9 with the associated taper element 10 and clamp ring 11 are removed and replaced in this design. To install a new structure drum 3, the procedure is reversed and first the new adapter ring 9 with the tapered element 10 and the associated clamp ring 11 fitted. New spacer elements 6 with a different distance to the suction pipe 2 are fixed to the said suction pipe 2 using the clamps 5. A new structure drum 3 can now be slid over the new spacer elements 6 and fixed at one end face using the tapered element 10, clamp ring 11 and adapter ring 9; and fixed at the operator end using the centering device 14. centering device 14. As can be seen in FIG. 4, the elements at the operator end B, i.e. bearing 13 and centering device 14, are identical in the two cases as the structure drum 3 with the end face are brought to a uniform size despite the different outer diameters. The design shown here with the adapted adapter ring 9 has the advantage that, with large structure drums 3, a higher torque can be transferred and the said drum has greater torsional stiffness.

In an alternative design, it is naturally also possible to create a uniform design of the fixing at the suction end S for all diameters of the structure drum 3, as realized for the operator end B. In addition, the connection of the end-face of the structure drum 3 to the adapter ring 9 is to be performed as diameter-independent so that the tapered element 10 and the clamp ring 11 can be applied universally.

In a replacement of the structure drum 3 by another of different diameter, only the spacer elements 6 and, in this design, the fixing elements of the suction end S, i.e. adapter ring 9, tapered element 10 and clamp ring 11 are to be kept in stock together with the structure drum 3.

The spacer elements 6 can be designed as round cylinders or with rectangular cross-section. They can be solid or have a drilled hole 6b along their longitudinal axis whereby the hole 6b corresponds to a hole in suction pipe 2 used to transport the liquid coming from the nozzles of the bonding plant to the suction pipe 2. With different spacer elements 6, various overall outer diameters of the drum 1 from 400 mm to 1200 mm can be realized.

With the invention, it is possible to fit structure drums 3 of various diameters to a suction pipe 2, whereby only new spacer elements 6 and, if necessary, the fixing elements of the suction end, i.e. adapter ring 9, tapered element 10 and clamp ring 11 have to be replaced. It is therefore no longer necessary each time the structure drum 3 is replaced, to purchase and put purchase and put in stock the matching suction pipe 2. The removal of the complete suction pipe 2 is also rendered unnecessary, so saving time taken and increasing plant availability.

### Reference Numbers

1 Drum
2 Suction pipe
3 Structure drum
5 Clamps 5a Recess
6 Spacer element
6a Foot
6b Drilled hole
7 Fastener
8 Bearing
9 Adapter ring
10 Tapered element
11 Clamp ring
12 Journal
13 Bearing
14 Centering device
B Operator end
S Suction end

1. Device for the hydrodynamic bonding of nonwovens, wovens or knitted fabrics comprising a suction pipe with a plurality of drilled holes, a structure drum set at a distance from the suction pipe, characterized by the distance between suction pipe and structure drum being set by spacer elements.

2. Device according to claim 1 characterized by the spacer elements being attached to the suction pipe.

3. Device according to claim 2 characterized by the spacer elements being attached to the suction pipe using clamps.

4. Device according to claim 3 characterized by the ability of the structure drum to be slid over the spacer elements.

5. Device according to claim 1, characterized in that the structure drum can be attached to the suction pipe in the region of the suction end by means of a replaceable adapter ring.

6. Device according to claim 5, characterized in that an end face of the structure drum engages in a recess of the adapter ring and can be fixed there by means of a tapered element and clamp ring.

7. Device according to claim 1, characterized in that an end face of the structure drum can be attached at the operator end to a centering device.

8. Device according to claim 7 characterized in that the centering device can be used universally for all outer diameters of structure drum.
